(19) United States
(12) Patent Application Publication
(10) Pub. No.: US 2010/0180260 A1
(43) Pub. Date: Jul. 15, 2010

(54) METHOD AND SYSTEM FOR PERFORMING AN AUTOMATED QUALITY ASSURANCE TESTING

(75) Inventors: Madhu Chandan Sunaganahalli Chikkadevaiah, Bangalore (IN); Girish Narayana Rao Basidoni, Bangalore (IN); Ramana Reddy Donthi Reddy Nagaraja, Bangalore (IN); Swethadhry Sharadamba Govinda, Bangalore (IN)

Correspondence Address: EVERGREEN VALLEY LAW GROUP, 4 North Second Street, Suite 598, SAN JOSE, CA, 95113, US

(73) Assignee: TestingCzars Software Solutions Private Limited, Bangalore (IN)

(21) Appl. No.: 12/726,357

(22) Filed: Mar. 18, 2010

(30) Foreign Application Priority Data
Jan. 10, 2009 (IN) 2402/CHE/2009

(51) Int. Cl. G06F 9/44

(52) U.S. Cl. 717/125; 717/131

(57) ABSTRACT

A method includes selecting a plurality of test cases. The method also includes designing the plurality of test cases to perform the automated quality assurance. The method further includes calibrating the plurality of test cases and manage the plurality of test cases in a visual hierarchy. The method also includes reflecting the functional modules in a cohesive group based on the calibration. The method further includes executing the plurality of test cases through at least one of a manual testing mode and an automatic testing mode. The method includes registering information associated with the plurality of test cases. Moreover the method includes generating one or more reports for the plurality of test cases. Furthermore the method includes displaying the one or more reports generated for the plurality of test cases on a visual interface.

### BACKGROUND

Over the years software testing is used as an investigation tool for providing information to one or more users about a quality of product or a service under test which it is intended to operate. The software development may not be possible if the product is not tested and the quality assurance is not provided using the software testing tool. The plurality of software's needs to be tested after its development in order to perform the desired functions as intended by the software developer and to avoid the software from performing various other functions which is not required.

In the existing technique, the plurality of software's are tested manually which consumes a sufficient amount of time and lacks consistency and reliability due to manual testing of software. Further in the existing technique, the manually testing of the plurality of software's is dependent on the skills of the one or more users involved in the process of manual software testing. Moreover in the existing technique, the software may not be tested accurately by the one or more users which lead to the software being tested repeatedly after every release with additional bugs. In the existing technique, the drawbacks of manually testing are overcome by automated testing using various tools, but the tools developed have very limited functionality and supports only specific technologies.

In the existing technique, the manually testing is overcome by using the recording and playback method, but the record and playback method uses scripts containing hard coded values which is subject to change if some changes occurs in the application. Further in the existing technique, the scripts need to be updated at regular intervals which consume sufficient amount of time and also the cost of maintenance for updating the scripts is high.

In the existing technique, the record and playback method may not work well in real time scenario as changes are made to the application at regular intervals to improve the performance and the reliability. Further in the existing technique, the one or more users testing software need to perform coding which in turn restricts automation testing for the non-technical users. In light of the foregoing discussion there is need of an efficient technique to over come the above mentioned problems.

### SUMMARY

An example of a method includes selecting a plurality of test cases. The method also includes designing the plurality of test cases to perform the automated quality assurance. The method further includes calibrating the plurality of test cases and manage the plurality of test cases in a visual hierarchy. The method also includes reflecting the functional modules in a cohesive group based on the calibration. The method further includes executing the plurality of test cases through at least one of a manual testing mode and an automatic testing mode. The method includes registering information associated with the plurality of test cases. Moreover the method includes generating one or more reports for the plurality of test cases. Furthermore the method includes displaying the one or more reports generated for the plurality of test cases on a visual interface.

An example of an article of manufacture includes a machine-readable medium, and instructions carried by the medium and operable to cause a programmable processor to perform selecting a plurality of test cases. The instructions cause the programmable processor to also perform designing the plurality of test cases to perform the automated quality assurance. The instructions cause the programmable processor to further perform calibrating the plurality of test cases and manage the plurality of test cases in a visual hierarchy. The instructions cause the programmable processor to perform reflecting the functional modules in a cohesive group based on the calibration. The instructions cause the programmable processor to also perform executing the plurality of test cases through at least one of a manual testing mode and an automatic testing mode. The instructions cause the programmable processor to further perform registering information associated with the plurality of test cases. Moreover the instructions cause the programmable processor to perform generating one or more reports for the plurality of test cases. Furthermore the instructions cause the programmable processor to perform displaying the one or more reports generated for the plurality of test cases on a visual interface.

An example of a system includes a server. The server includes an administrator module and a client module. The client module is used for selecting a plurality of test cases, capturing a component metadata and a data associated with the plurality of test cases to be tested by a single click and selecting at least one of the manual testing mode and the automatic testing mode to design the plurality of test cases. The client module includes a processor. The processor includes a designer for designing the plurality of test cases to perform the automated quality assurance, calibrating the plurality of test cases and manage the plurality of test cases in a visual hierarchy. And reflecting the functional modules in a cohesive group based on the calibration. The processor further includes an executer for executing the plurality of test cases through at least one of a manual testing mode and an automatic testing mode. The processor includes a registry for registering information associated with the plurality of test cases, wherein the registering comprises managing component registry information. The processor also includes a reporter for generating one or more reports for the plurality of test cases based on the registration of information. The client module includes a visual interface for displaying the one or more reports generated for the plurality of test cases in a grid format with project phase being denoted in the timeline of the project in one axis and the test type being denoted in the phase of testing as another axis on a visual interface in the client module.

### BRIEF DESCRIPTION OF FIGURES

FIG. 1 illustrates a block diagram for performing an automated quality assurance test, in accordance with one embodiment of the invention;

FIG. 2 illustrates a block diagram of the client module, in accordance with one embodiment of the invention;

FIG. 3 illustrates a block diagram of the client-server architecture implemented in the system, in accordance with one embodiment of the invention;

FIG. 4a-4b illustrates a flow diagram for performing an automated quality assurance test, in accordance with one embodiment of the invention;

FIG. 5a-5b is a flowchart illustrating a method, in accordance with one embodiment of the invention;

FIG. 6 is a flow chart illustrating the testing sequence implemented in present invention, in accordance with one embodiment of the invention;

FIG. 7 is a flow chart illustrating the sequence of designing the test, in accordance with one embodiment of the invention;

FIG. 8 is a flow chart illustrating the sequence of executing the test, in accordance with one embodiment of the invention;

FIG. 9 is a flow chart illustrating the sequence of test report generation, in accordance with one embodiment of the invention;

FIG. 10a-10b is a schematic view illustrating a user interface used for implementing the test design, in accordance with the one embodiment of the invention;

FIG. 11 is a schematic view illustrating a user interface used for implementing the application under test component management, in accordance with the one embodiment of the invention;

FIG. 12 is a schematic view illustrating a user interface used for implementing the test execution, in accordance with the one embodiment of the invention; and

FIG. 13 is a schematic view illustrating a user interface used for implementing the test report generation, in accordance with the one embodiment of the invention.

### DETAILED DESCRIPTION OF THE EMBODIMENTS

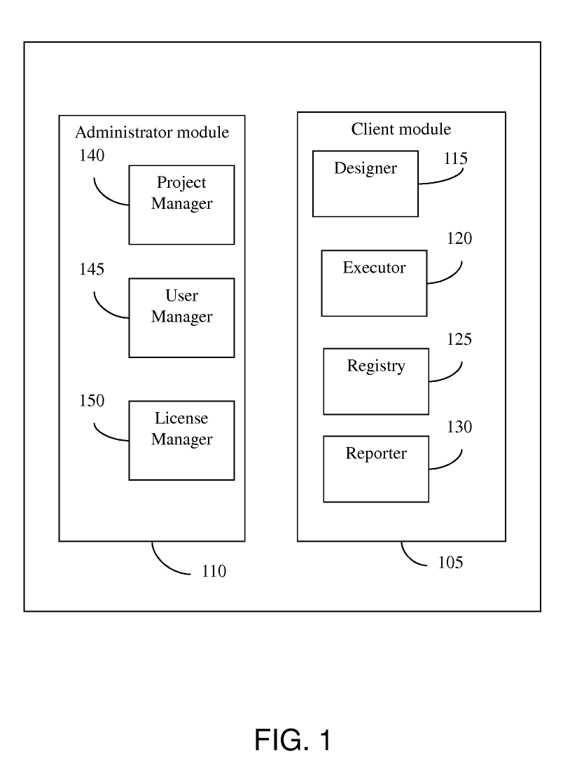

FIG. 1 illustrates a block diagram for performing an automated quality assurance test, in accordance with one embodiment of the invention.

The block diagram includes a client module 105 and an administrator module 110. The client module 105 includes a designer 115, an executor 120, a registry 125 and a reporter 130. The administrator module 110 includes a project manager 140, a user manager 145 and a license manager 150. The Client module 105 includes the designer 115 for generating the test cases for automated and Manual Testing. The client module 105 further includes the executor 120 for executing the test through at least one of the manual and automated testing mode. The client module 105 includes the registry 125 for storing the properties of the test components of the application under test. The client module 105 also includes the reporter 130 for generating the test reports for analysis and bug reporting.

The administrator module 110 is used for managing various test activities. The administrator module 110 includes the project manager 140 for creating a project along with the project details. The project details include but are not limited to a description of the project, one or more users of the project, and one or more configuration details of the project. The one or more configuration details of the project include at least one of a project database, one or more communication methods, a user access management and an administrator privileges.

The administrator module 110 also displays the status of the project along with the one or more details. The details include, but are not limited to, number of active projects, number of logged-in users and the list of logged-in users for a given project. The administrator module 110 provides the ability to choose a database which resides across the network for a given project. The administrator module 110 also provides an option to select one or more databases for various projects. The project manager 140 in the administrator module 110 also provides an option to suspend the project from use or re-activate the project for use. The project manager 140 includes an event viewer for capturing one or more events to generate an event log for the purpose of traceability and audit of purpose. The project manager 140 also provides an option for a user to login and get authenticated with a central admin system in order to receive the users profile, meta-data, access to projects and permissions.

The administrator module 110 includes the user manager 145 for creating the users and assigning permissions to the subsystems of the designer 115, executor 120, registry 125 and the reporter 130 in the client module 105. The permissions assigned include, but are not limited to, create, view, modify and delete. The administrator module 110 also includes the license manager for monitoring the various license activities assigned to one or more client terminals.

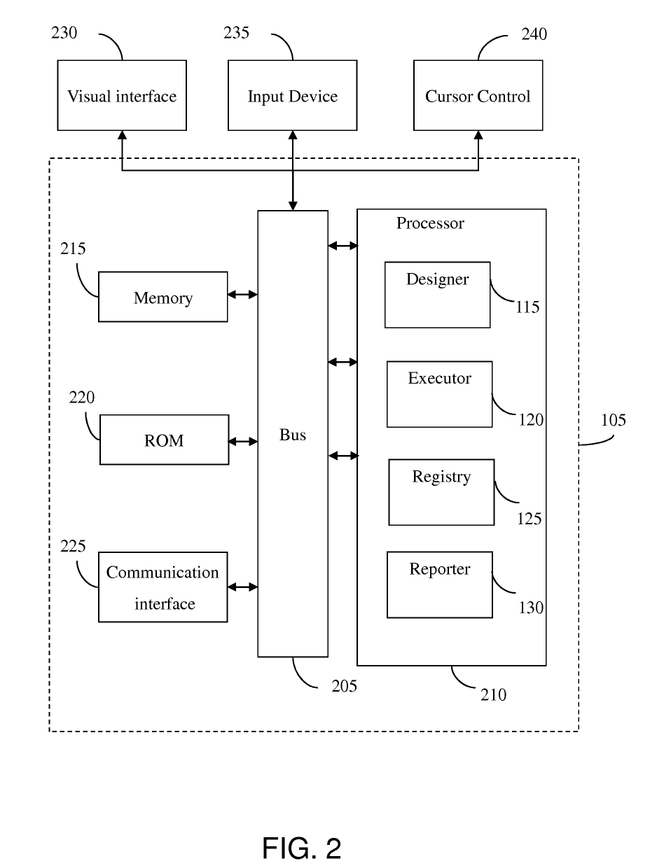

FIG. 2 illustrates a block diagram of the client module 105, in accordance with one embodiment of the invention.

The client module 105 includes a bus 205 or other communication mechanism for communicating information, and a processor 210 coupled with the bus 205 for processing information. The client module 105 also includes a memory 215, such as a random access memory (RAM) or other dynamic storage device, coupled to the bus 205 for storing information and instructions to be executed by the processor 210. The memory 215 can be used for storing temporary variables or other intermediate information during 0execution of instructions to be executed by the processor 210. The client module 115 further includes a read only memory (ROM) 220 or other static storage device coupled to the bus 205 for storing static information and instructions for the processor 210.

The client module 105 can be coupled via the bus 205 to a visual interface 230, such as a cathode ray tube (CRT), liquid crystal display (LCD) for displaying information to a user. The visual interface 230 is used for displaying the one or more reports generated for the plurality of test cases in a grid format with project phase being denoted in the timeline of the project in one axis and the test type being denoted in the phase of testing as another axis on a visual interface 230 in the client module 105.

An input device 235, including alphanumeric and other keys, is coupled to the bus 205 for communicating information and command selections to the processor 210. Another type of user input device is a cursor control 240, such as a mouse, a trackball, or cursor direction keys for communicating direction information and command selections to the processor 210 and for controlling cursor movement on the visual interface 230.

Various embodiments are related to the use of the client module 105 for implementing the techniques described herein. In one embodiment, the techniques are performed by the client module 105 in response to the processor 210 executing instructions included in the memory 215. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the client module 105, various machine-readable medium are involved, for example, in providing instructions to the processor 210 for execution. The machine-readable medium can be a storage media. Storage media includes both non-volatile media and volatile media. Non-volatile media includes, for example, optical or magnetic disks. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that include the bus 205. Transmission media can also take the form of acoustic or light waves, such as those generated during radio-wave and infra-red data communications. Examples of machine-readable medium may include but are not limited to a carrier wave as describer hereinafter or any other medium from which the client module 105 can read, for example online software, download links, installation links, and online links.

The client module 105 also includes a communication interface 225 coupled to the bus 205. The communication interface 225 provides a two-way data communication. For example, the communication interface 225 can be an integrated services digital network (ISDN) card or a modem to provide a data communication connection to a corresponding type of telephone line. As another example, the communication interface 225 can be a local area network (LAN) card to provide a data communication connection to a compatible LAN. Wireless links can also be implemented. In any such implementation, the communication interface 225 sends and receives electrical, electromagnetic or optical signals that carry digital data streams representing various types of information.

The client module 105 can receive the plurality of inputs through the communication interface 225. The inputs are processed by the processor 210 using one or more processing modules. The processing modules may be incorporated within the processor 210 or may be stand-alone that communicate with the processor 210. The one or more processing modules include the designer 115, the executor 120, the registry 125 and the reporter 130. The processor 210 includes the designer 115 for designing the plurality of test cases to perform the automated quality assurance test, calibrating the plurality of test cases and managing the plurality of test cases in a visual hierarchy and reflecting the functional modules in a cohesive group based on the calibration. The processor 210 includes the executer 120 for executing the plurality of test cases through at least one of a manual testing mode and an automatic testing mode. The processor 210 includes the registry 125 for registering information associated with the plurality of test cases. The registering includes managing component registry information. The processor 210 also includes the reporter 130 for generating one or more reports for the plurality of test cases based on the registration of information.

In another embodiment, the client module 105 may not include the processing modules and the functions of the processing modules can be performed by the processor 210 in response to the instructions.

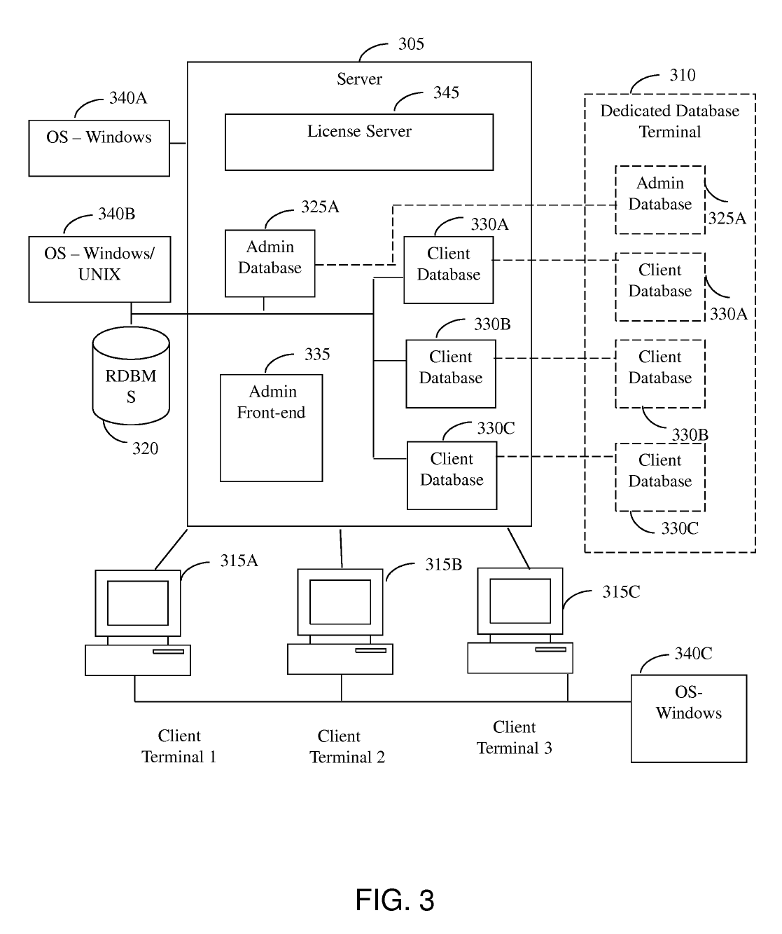

FIG. 3 illustrates a block diagram of the client-server architecture implemented in the system, in accordance with one embodiment of the invention.

The functions of the designer 115, the registry 120, the executor 125, and the reporter 130 are performed through a set of algorithms in the present invention.

The client-server architecture includes a server 305, a dedicated database terminal 310, one or more client terminals, for example, a client terminal 1 315A, a client terminal 2 315B, and a client terminal 3 315C and a Relational database management system (RDBMS) 320.

The server 305 is used for managing the one or more databases of the client module 105 and database of the administrator module 110. The database of the administrator module 110 is an admin database 325A. The one or more databases of the client module are a client database 330A, a client database 330B, and client database 330C.

The server 305 includes an admin front-end 335 for providing the user with the visual interface to perform various operations related to the administrator module 110.

The server 305 is used for managing the one or more license activities and test activities associated with the one or more client terminals. The server runs on windows operating system 340A. The one or more databases run on either windows or UNIX operating system 340B. The one or more client terminals run on the Windows operating system 340C.

In one embodiment, the one or more databases of the administrator module 110 and client module 105 are managed in a separate terminal known as the dedicated database terminal 310. The dedicated database terminal 310 is used only for database management. The one or more databases of the administrator module 110 and the client module 105 are also complied with the relational database management system (RDBMS) 320. An option is also provided to modify the one or attributes related to the component and select a database for the project across a network. The one or more users and assign permissions are also created. The one or more users and assign includes a create, a view and a delete.

The server 305 also includes a license manager 345 for managing the various activities related to the licenses. The licenses are assigned to the one or more client terminals through a license server 345. The license server 345 generates a unique license key for the one or more client terminals. The license assigned to the one or more client terminals includes at least one of a node-locked mode, a floating mode and a subscription license mode.

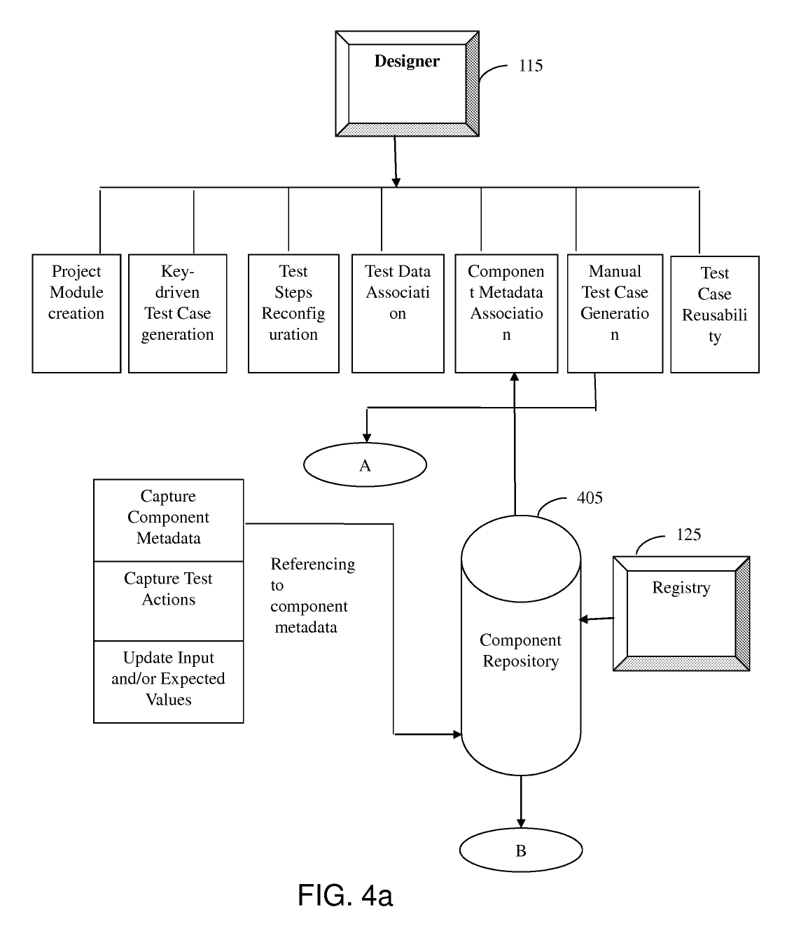

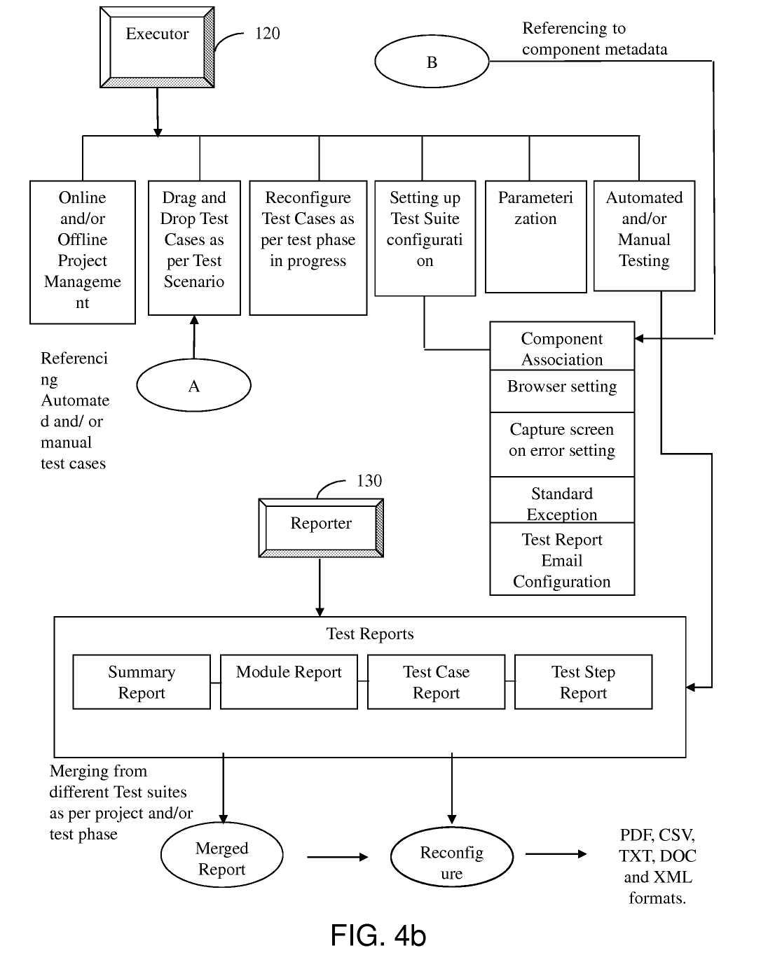

FIG. 4a-4b illustrates a flow diagram for performing an automated quality assurance test, in accordance with one embodiment of the invention.

The designer 115 is used for performing the following functions. The functions performed by the designer 115 include creating a project module corresponding to the application under test The function performed by the designer 115 further includes generating the test case for automated testing using the keyword-driven approach. The Test Case generation involves capturing a component metadata and a data associated with the plurality of test cases to be tested by a single click. The captured component metadata are managed in a component repository 405 in the registry 125. The captured component metadata is used as reference during the modification of the test step. The component repository 405 is used for storing a list of one or more components captured across the user interface of the application under test. The input values and expected values corresponding to each component are updated in the test case. The test case for automatic testing is generated by a single click on a TC generator. The Test Case for manual testing is either created manually or generated automatically by the single click on MT generator. The plurality of test cases includes at least one of a set of test data, and test programs. During the process of designing the user interactions and behavior corresponding to the application under test are captured. The one or more test steps required for execution of the plurality of test cases are generated and then one or more input variables are captured automatically for the one or more steps generated. The one or more expected results are defined for the one or more input variables.

The functions performed by the designer 115 also include providing an option to reconfigure one or more test steps in the test Case. An option is provided to change the sequence of the one or more test steps and to add an additional step during the capture of the test step. A template file is also generated to capture an input data for the plurality of test cases. The template file can be fed as an input from an external source. The template file is an external input data file. A test case documentation is also generated through selection of at least a test case, a test step and a test. In one embodiment, a data file associated during the creation of the test case is overridden in at least one of the test step and the test case with the external input data file.

In another embodiment, the one or more test steps in the test case can be skipped and reconfigured based on formulation of test scenarios. In some embodiments, when a need arises to repeat the test cases for specific test scenarios, then the test cases can be re-used instead of repeating the one or more test steps in the test cases.

The functions performed by the designer 115 include providing an option to associated test data during parameterization. The captured component metadata and the data are associated with the plurality of test cases. The plurality of test cases is designed by selecting at least one of the manual testing mode and the automatic testing mode. In designing the test case the user interactions and behavior corresponding to the application under test are captured. The user interactions captured can also be modified.

After designing of the test case for the application under test, the test execution is performed in the executor 120. The executor 120 is used for performing the following functions. The functions performed by the executor 120 include offline and online management of the projects. During execution one or more labels are created for the project time lines. The one or more labels created can be used as a tag to apply on the project denoting the phase of the project in the overall Project development life cycle (PDLC). A test suite is also created and managed for application under test. Further during execution one or more test types are created and managed. The one or more test types can be used as a tag to apply on the test suite denoting the phase of test.

The functions performed by the executor 120 include providing an option to drag and drop the plurality of test cases generated through the automated and the manually testing into the test suite according to the test scenario. The summary level details of the test case are also captured to describe the test case, test conditions, test assumptions, test risks based on a pre-set of language of choice. The captured summary details include at least one of a date of creation, an information pertaining to created user, a date of modification, one or more modified details, a test case purpose and a test case status.

During execution, the plurality of test cases can be reconfigured within the test suite according to the business requirements. Further certain test cases can also be skipped within the test Suite. The one or more test scenarios are also configured with one or more component repositories to provide an option to select the runtime environment. The configuration settings include selecting a browser of choice to be used for the application under test snapshot of the screen on error and generate one or more messages to notify status of execution. The configuration settings also include providing an option to define exception handlers and component repository association.

The test data files are also checked for parameterization. The Designer 115 includes a test data generator for generating test data file during parameterization. The generated Test Data file includes information corresponding to object names updated in column headers automatically. The test data file is attached in a test data file name pane within the test case level configuration header group after updating the data required for parameterization.

The type of execution to be performed is selected and the test is executed through at least one of the manual mode and the automatic mode in the trial run. Further an option is also provided to stop, pause and restart the execution in the trial run. The test execution progress status is displayed on execution board that opens immediately after running the test. The plurality of test cases that are passed, failed and skipped are displayed on the execution board.

The functions performed by the reporter 120 include generating one or more test reports based on the execution for a category of users. The one or more test reports represent the test execution status. The one or more reports generated include a high level report, a low level report, a summary report, a module report, a test case report and the test step report. The summary report provides information of the overall execution status of the plurality of test cases in the test suite both theoretically and diagrammatically.

The module report provides information about the execution status of the plurality of test Cases in the project module. The test case report provides information about the execution status of the plurality of test cases in a particular test suite. The test step report provides information about the execution status of each test step in every test case of the Test Suite.

The functions performed by the reporter 120 also include configuring the one or more reports generated and merging the reports of the one or more test scenarios into a single report for the project. The one or more reports generated can also be exported into various formats. The various formats include but are not limited to DOC, PDF, CSV, TXT and XML file formats.

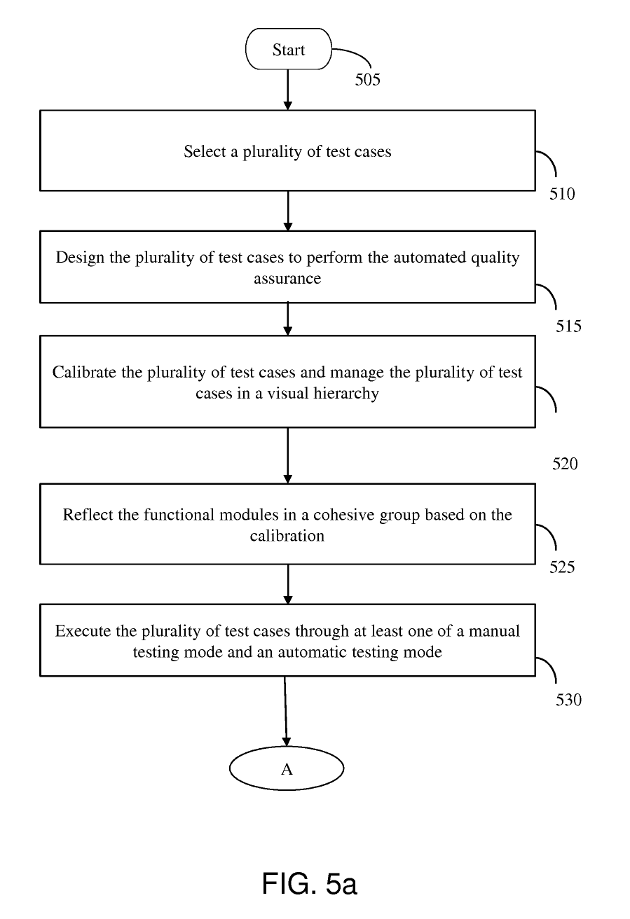

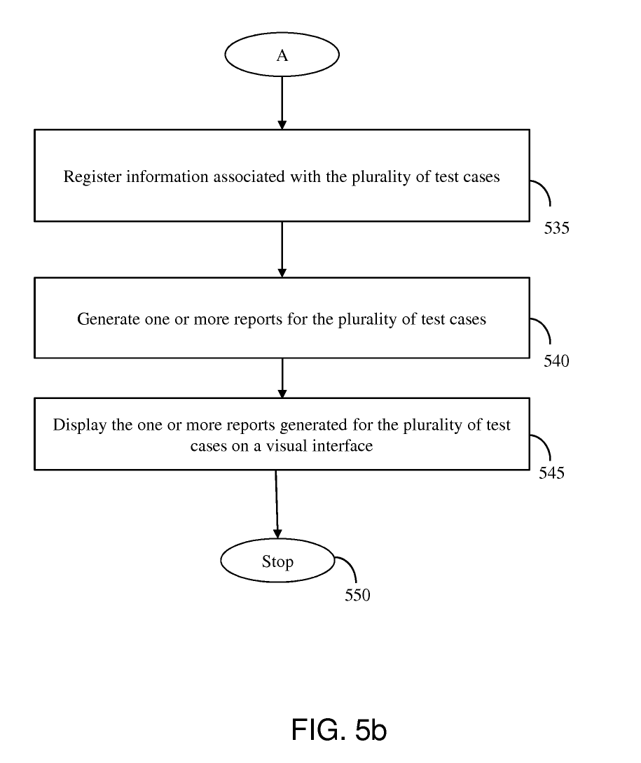

FIG. 5a-5b is a flowchart illustrating a method, in accordance with one embodiment of the invention.

At step 505, a method starts.

At step 510 a plurality of test cases is selected.

At step 515, the plurality of test cases is designed to perform the automated quality assurance test.

At step 520, the plurality of test cases are calibrated and managed in a visual hierarchy.

At step 525, the functional modules in a cohesive group are reflected based on the calibration.

At step 530, the plurality of test cases is executed through at least one of a manual testing mode and an automatic testing mode.

At step 535, the information associated with the plurality of test cases is registered.

At step 540, the one or more reports are generated for the plurality of test cases.

At step 545, the one or more reports generated are displayed for the plurality of test cases on a visual interface.

The method stops at 550.

FIG. 5a-5b has been explained in great detail in conjunction with the following drawings.

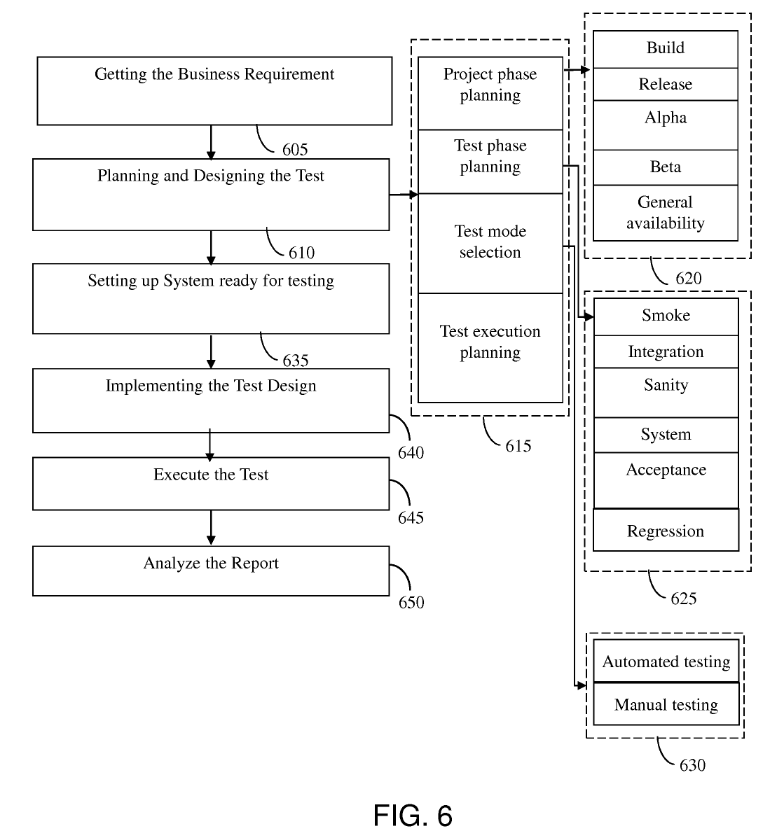

FIG. 6 is a flow chart illustrating the testing sequence implemented in present invention, in accordance with one embodiment of the invention.

At step 605, the business requirement for a project is received in order to understand client needs.

At step 610, the test is planned and designed. The designing of the test plan for the project involves project phase planning, test phase planning, test mode selection and test execution planning as illustrated in step 615.

In the project phase planning of designing, the phase of the project is determined based on the business requirement. The one or more phases of the project includes but are not limited to build, release, alpha, beta and general availability (GA) of the project as illustrated in step 620.

In the test phase planning of designing, the type of testing that needs to be performed with respect to the Application under test is determined based on the business requirement. The one or more test types include but are not limited to a smoke, an integration, a sanity system, an acceptance, and a regression as illustrated in step 625.

In the test mode selection of designing, the type of testing is selected for the Application under test. The type of testing selected includes at least one of the manual mode and automatic mode as illustrated in step 630.

At step 635, the system is setup for testing the project. The system is setup after the test plan is prepared for the project based on the business requirement.

At step 640, the test design is implemented for the test plan determined in the planning and designing phase. Further during implementation the project phase and the test phase planning of designing are tagged. The one or more labels are used for tagging the project phase and the test phase planning of designing.

At step 645, the test is executed for the Application under test based on the type of mode selected. The test execution results are determined in a test report in the form of theoretical and diagrammatic representation of the detailed execution status of the test.

At step 650, the test report is analyzed.

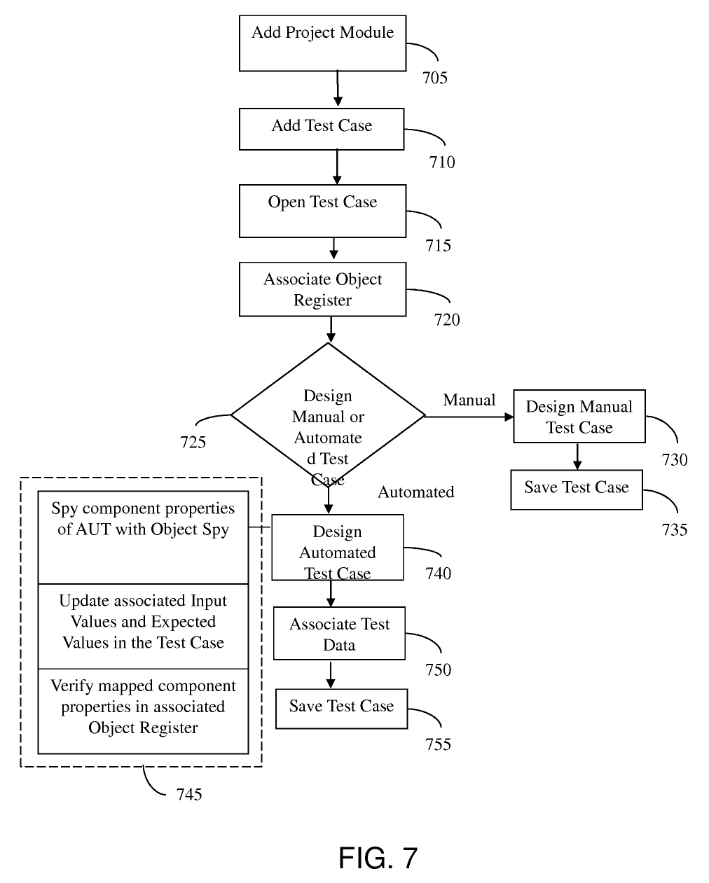

FIG. 7 is a flow chart illustrating the sequence of designing the test, in accordance with one embodiment of the invention.

At step 705, a project module is added.

At step 710, a test case is added.

At step 715, the test case is opened. The type of test case to be generated is determined based on the type of testing to be performed with the AUT. The automation steps page is selected to perform automated testing in the Test Case Grid View. The Manual Steps page is selected to perform manual testing.

At step 720, the object register is associated. An object Inventory is created within the project module in the registry. In test case level configuration header group, an object inventory is associated with the test Case inside the associated object register pane.

At step 725, a decision is taken whether to design the test case manually or automatically. If the test case is designed manually then step 730 is performed, else step 740 is performed.

At step 730, the test case is designed manually. The Designer includes the Manual Test case (MT) generator for generating the one or more test steps for Manual Test Case. The manual test case is generated by referring to action names, object names, input values and expected values of the automated Test Case generated previously. In one embodiment, the Manual Test case (MT) generator generates the manual test case, only if the automated Test Case is generated previously, else the test steps needs to be manually entered by a user.

At step 735, the test case designed manually is saved.

At step 740, the test case is designed automatically. The automated test Case generation is initiated by spying component properties of application under test with object spy. The component properties are mapped with the object spy. After mapping, one or more object names and action names of the mapped component properties are automatically updated in the test case grid view. The component properties are also updated simultaneously in the associated object inventory in the Registry. The component properties include attributes and values of the test components. Further the input values representing the data to be entered in the test components and the expected values representing the data to be verified in the test components are fed as input corresponding to the test components in the test case as illustrated in step 745.

At step 750, test data is associated.

At step 755, the test case designed automatically is saved. The test case generation for automated testing is completed after saving the test Case.

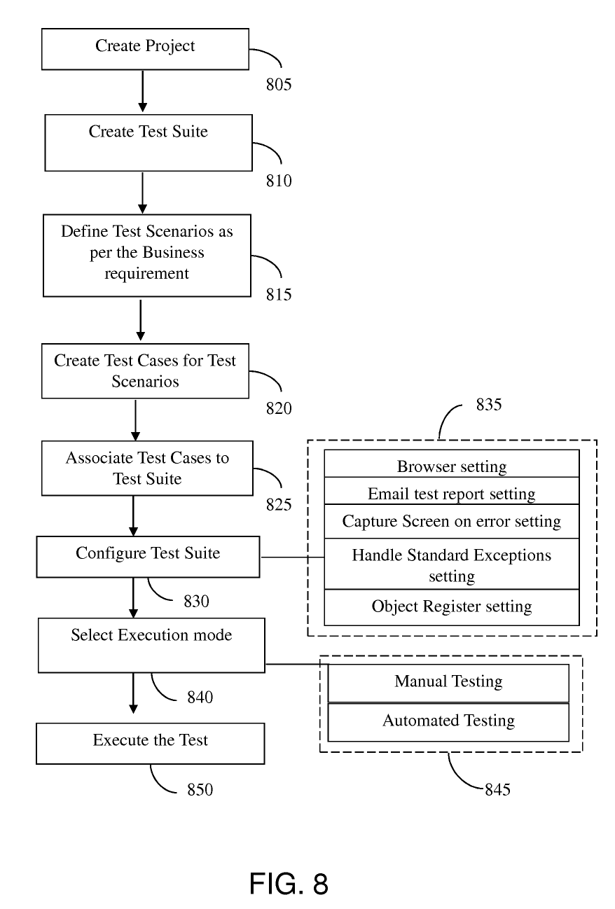

FIG. 8 is a flow chart illustrating the sequence of executing the test, in accordance with one embodiment of the invention.

At step 805, a project is created according to the business requirement. The project is created with one or more project details. The one or more project details include a description of the project, one or more users of the project, and one or more configuration details of the project. The one or more configuration details of the project include a project database, one or more communication methods, an user access management and an administrator privileges.

The one or more labels are also created for the project time lines. The one or more labels are managed for the project time lines. The one or more labels can be used as a tag to apply on the project denoting the phase of the project in the overall Project development life cycle (PDLC). The one or more labels created include at least one of a build, a release, an alpha, and a beta and a general availability.

At step 810, a test suite is created. The test suite created is then managed for the application under test. The one or more test types are also created for the test suite. The one or more test types can be used as a tag to apply on the test suite denoting the phase of test. The one or more test types include but are not limited to a smoke, an integration, a sanity system, an acceptance, and a regression. The one or more test types include customizing one or more tags to apply for the test suite and the test case and applying one or more tags to annotate the test suite and the test case in order to represent the test suite as at least one of the test type during phases of testing. In one embodiment, the one or more tags are also promoted to denote the change in the test phase.

At step 815, one or more test scenarios are defined according to the business requirement.

At step 820, plurality of test cases is created for the test scenarios. The plurality of test cases relevant to the one or more test scenarios is grouped.

At step 825, the one or more test cases are associated with the one or more test suites.

At step 830, the one or more test suites are configured. The one or more test scenarios are configured with one or more component repositories to provide an option to select the runtime environment. An option is then provided to execute the one or more test scenarios on the test suite by the single click. The configuration settings include selecting a browser of choice to be used for the application under test snapshot of the screen on error and generate one or more messages to notify status of execution. The configuration settings further include providing an option to define exception handlers and component repository association as illustrated in step 835.

At step 840, the execution mode is selected to run the plurality of test cases. The execution mode selected is at least one of the manual mode and the automatic mode as illustrated in step 845.

At step 850, the plurality of test cases are executed based on the execution mode selected in step 840. An option is also provided to stop, pause and restart the execution in the trial run. Further during execution a response is captured from the application under test. The execution screenshot is captured of the one or more test scenarios with the project phase and the test phase based on a journal system. After capturing the response, the response is validated from the application under test and the one or more sessions with the one or more test suites are executed. The results drawn from execution are then analyzed based on the captured response and the execution snapshot.

In one embodiment, the one or more sessions are executed in at least one of a background mode, and a foreground mode.

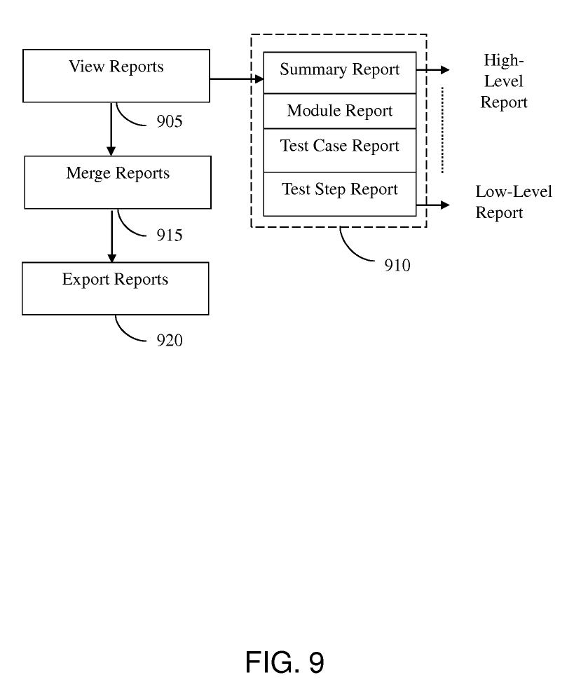

FIG. 9 is a flow chart illustrating the sequence of test report generation, in accordance with one embodiment of the invention.

At step 905, the one or more reports generated are viewed. The one or more reports are generated based on the execution for a category of users. The one or more reports are generated with a dimension of the project phase and the test phase with respect to time based on a journal system. The one or more reports generated include at least one of the high level report, the low level report, the summary report, the module report, the test case report and the test step report as illustrated in step 910. The summary report summarizes the project execution status, for example, pass, fail and not executed status, and execution timestamp of the project along with the details of the user involved in the execution the test. The module report provides information about the execution status and percentage of execution of various test scenarios of the project. The Test Case report provides information about the execution status and execution timestamp of each individual test case in the test scenario. The Test Step report provides information about the execution status of each test step along with the details of the test components, test step and execution time. In one embodiment, the screenshot of the test step that encountered error to facilitate bug tracking is also displayed to the user.

At step 915, the one or more reports are merged. The one or more reports generated for different test scenarios are merged into a single report for the project.

At step 920, the one or more reports are exported. The one or more reports generated can also be exported into various formats. The various formats include but are not limited to DOC, PDF, CSV, TXT and XML file formats.

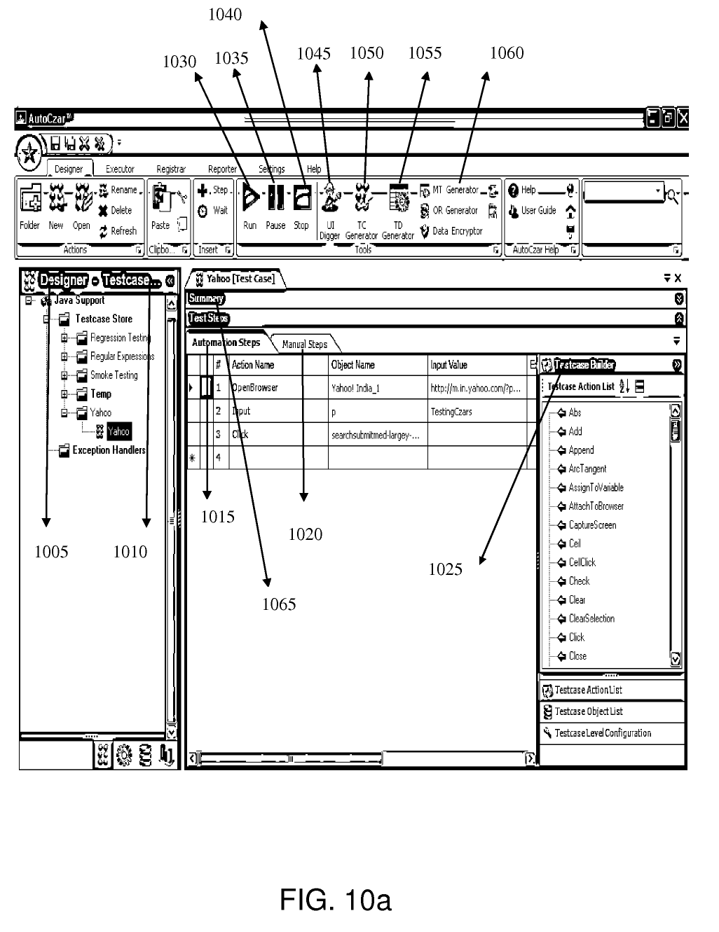

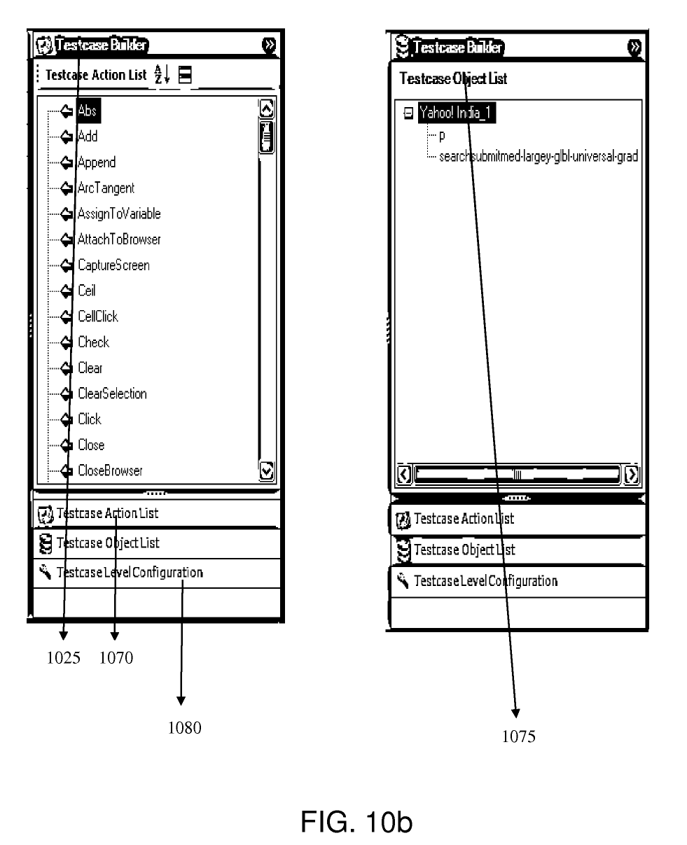

FIG. 10a-10b is a schematic view illustrating a user interface used for implementing the test design, in accordance with the one embodiment of the invention.

The designer view 1005 is selected to initiate the process of designing. The designing of a test case is started by adding a project module in the Designer Tree view. The test cases 1010 are added into the project module. The type of test case to be generated is determined based on the type of testing to be performed with the application under test. The automation steps page 1015 is selected to perform automated testing in the test case grid view. The manual steps page 1020 is selected to perform manual testing in the test grid view.

The schematic view further includes a test case builder header group 1025. The designer view 1005 provides an option to perform at least one of a run 1030, a pause 1035, and a stop 1040 actions on the plurality of test cases to be designed. The automated test case generation is initiated by the TC generator 1050. The TC generator 1050 includes an object spy to spy the properties of the test components in the application under test. The component properties are mapped with the object spy. The object names and action names of the mapped component properties are automatically updated in the test case grid view.

The designer view 1005 includes a Test data (TD) generator 1055 for generating Test Data file during parameterization. The generated Test Data file contains all the object names updated as column headers automatically. The designer view 1005 also includes a Manual Test Case (MT) generator 1060 for generating one or more steps for Manual test case with reference to the action names, object names, input values and expected values of the automated Test Case generated previously.

The designer view 1005 includes a summary header group 1065 for providing information about the purpose and details of a particular test case. The designer view 1005 includes the test case action list 1070 for providing a list of test actions to be performed with respect to the test components in the application under test. The designer view 1005 further includes test case object list 1075 for displaying the object inventory associated with the test case for quick reference of the component properties. The designer view also includes a test case level configuration 1080. The Test Case generation is then completed in the designer 1005.

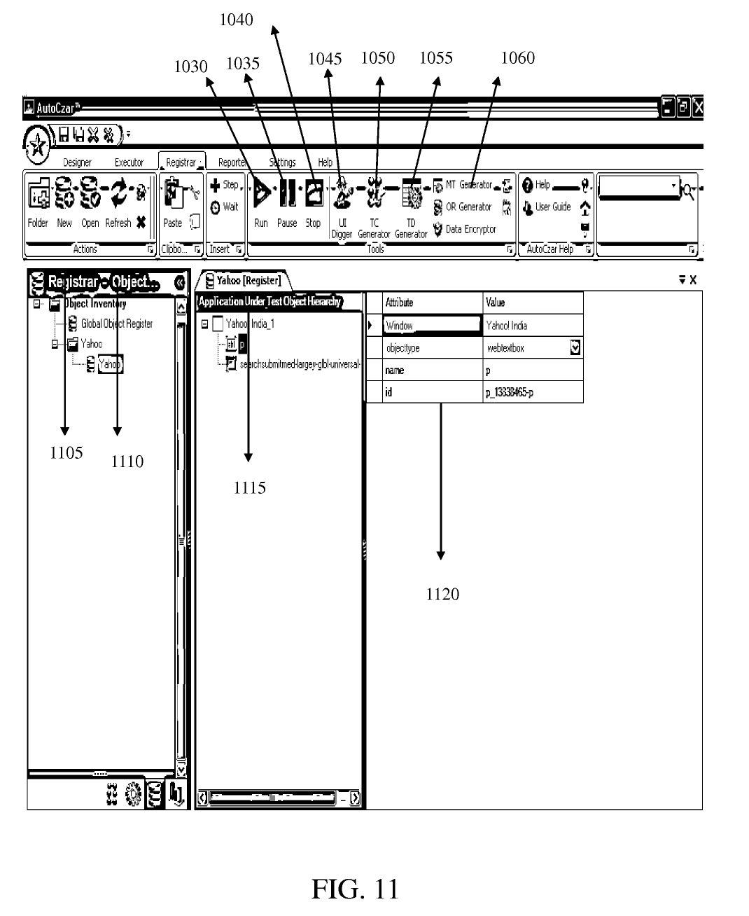

FIG. 11 is a schematic view illustrating a user interface used for implementing the application under test component management, in accordance with the one embodiment of the invention.

The registry view 1105 is selected to initiate the process of registering information associated with the plurality of test cases. The registry view 1105 includes an object register 1110 for maintaining repository of the component properties mapped with the object spy. The registry view 1105 includes a Tree view for storing the project module folder and object repository of the application under test. The registry also includes a component tree view 1115 that contains the actual component properties with matching icons. Each component property in the component tree view 1115 includes attributes and values associated with the components displayed in a separate grid 1120.

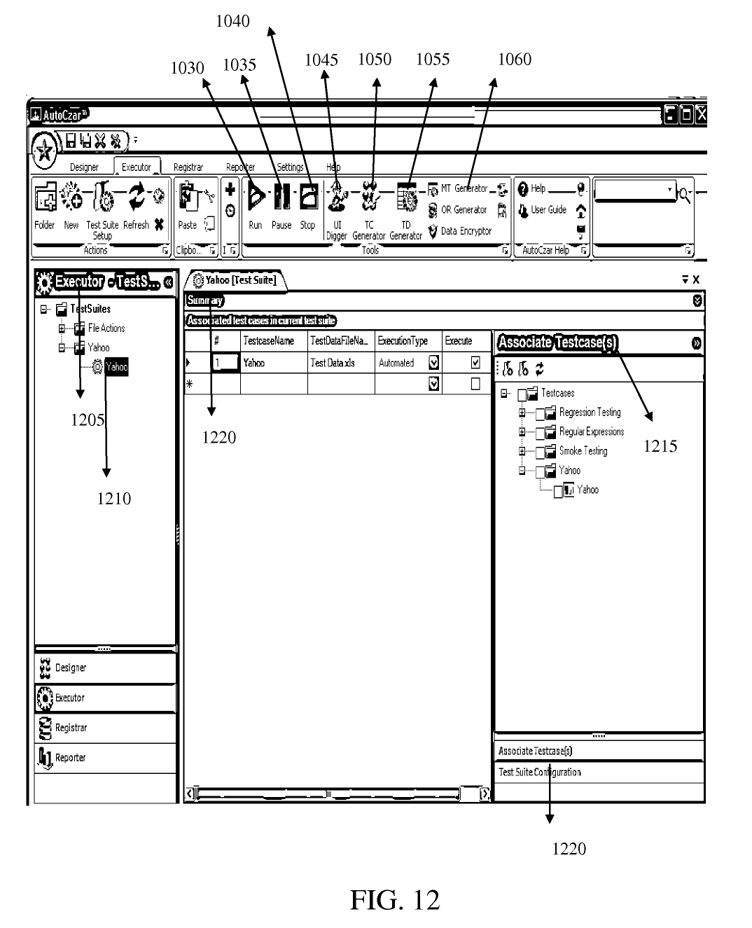

FIG. 12 is a schematic view illustrating a user interface used for implementing the test execution, in accordance with the one embodiment of the invention.

The test execution is performed in the executor view 1205. The test execution is initiated by creating a project according to the business requirement in the tree view 1210. The one or more labels are also created for the project time lines. The one or more labels can be used as a tag to apply on the project denoting the phase of the project in the overall Project development life cycle (PDLC). The one or more labels created include at least one of a build, a release, an alpha, and a beta and a general availability.

A test suite is then created and managed for the application under test. The one or more test types are also created for the test suite. The one or more test types can be used as a tag to apply on the test suite denoting the phase of test. The one or more test types include but are not limited to a smoke, an integration, a sanity system, an acceptance, and a regression. The one or more test scenarios are defined for the project according to the business requirement. The test cases relevant to a particular test scenario are grouped and associated within a test Suite by adding the test Cases from the tree view 1210 in the associate test case header group 1215. A test suite configuration 1220 is followed with the subsequent settings in the configuration header group. The mapping of object repository setting includes mapping of the object register associated with the Test Cases from the tree view 1210 in object register group box. The details of the user who created and modified the test suite with timestamp are displayed on the summary header group 1220. The Test Suite is executed by clicking on the RUN button 1030 in the Executor ribbon tab. The Run Dialog box opens for specifying the Run Name and type of testing to be performed. The user is also provided an option to define the Run Name for the test execution. Further once the test execution is started, an execution board opens displaying the execution progress status and overall execution status of the test. The test execution can be either paused 1035 or stopped 1040 with corresponding buttons provided in the visual interface.

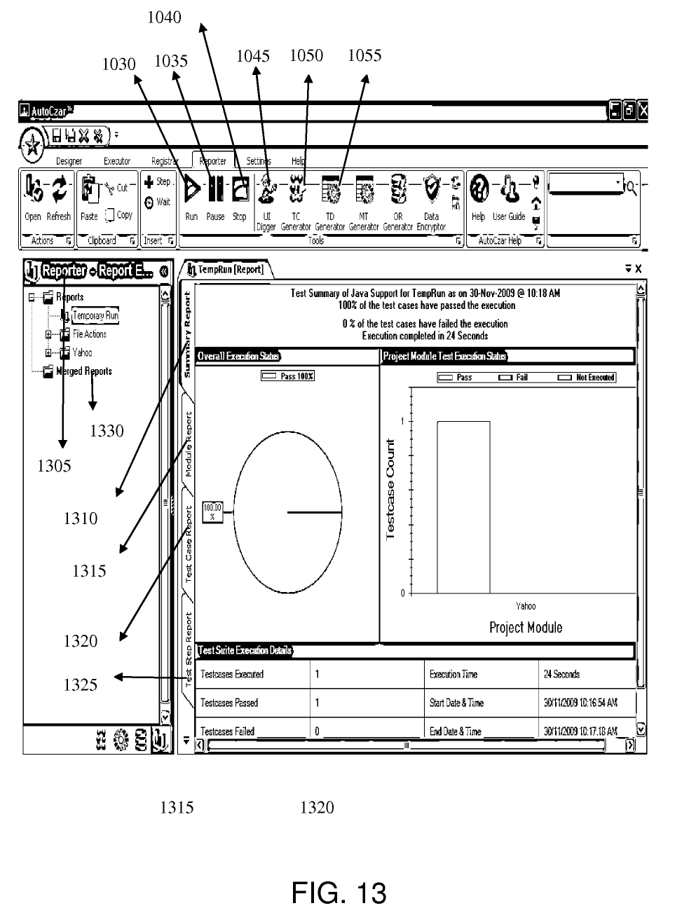

FIG. 13 is a schematic view illustrating a user interface used for implementing the test report generation, in accordance with the one embodiment of the invention.

The one or more reports are generated in the reporter view 1305. The one or more reports generated are viewed to the users. The one or more reports are generated based on the execution for a category of users. The one or more reports generated include at least one of a high level report, a low level report, a summary report 1310, a module report 1315, a test case report 1320, and a test step report 1325. The one or more reports generated can also be configured. The configuration of reports includes retaining the one or more reports generated in complete. The configuration further includes overriding the one or more reports and retain a latest report generated after execution.

The summary reports 1310 summarizes the project execution status, for example, pass, fail and not executed status, and execution timestamp of the project along with the details of the user involved in the execution the test.

The module report 1315 provides information about the execution status and percentage of execution of various test scenarios of the project.

The test case report 1320 provides information about the execution status and execution timestamp of each individual test case in the test scenario.

The test step report 1325 provides information about the execution status of each test step along with the details of the test components, test step and execution time. In one embodiment, the screenshot of the test step that encountered error to facilitate bug tracking is also displayed to the user.

The one or more reports are merged and are known as merged reports 1330. The one or more reports generated for different test scenarios are merged into a single report for the project. The one or more reports generated can also be exported into various formats. The various formats include but are not limited to DOC, PDF, CSV, TXT and XML file formats.

In one embodiment, the present invention generates a test case, a component repository, a test suite and a report using a script less approach. Thereby eliminating the need for coding and consumes very less amount of processing time, which in turn is cost effective to the end users. Further the present invention provides an option to providing an option for a user to login and get authenticated with a central admin system in order to receive the users profile, meta-data, access to projects and permissions.

In another embodiment, the present invention provides an option to reconfigure, skip, and reuse the plurality of test cases. The present invention provides an option to rearrange the one or more test steps in the test case and also to add a test case in use within the test case.

In some embodiment, the visual interface includes a dashboard for displaying the one or more statics and details related to the project.

In some embodiments, the present invention can be used for both automated and manual testing of applications. The applications include but are not limited to web and desktop applications.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. An article of manufacture for performing an automated quality assurance, the article of manufacture comprising:
selecting a plurality of test cases;
designing the plurality of test cases to perform the automated quality assurance;
calibrating the plurality of test cases and manage the plurality of test cases in a visual hierarchy;
reflecting the functional modules in a cohesive group based on the calibration;
executing the plurality of test cases through at least one of a manual testing mode and an automatic testing mode;
registering information associated with the plurality of test cases, wherein the registering comprises managing component registry information;
generating one or more reports for the plurality of test cases; and
displaying the one or more reports generated for the plurality of test cases on a visual interface.

2. The article of manufacture of claim 1, wherein the plurality of test cases comprises at least one of:
a set of test data; and
test programs.

3. The article of manufacture of claim 1 comprising: a set of algorithms for performing at least one of:
capturing a component metadata and a data associated with the plurality of test cases to be tested by a single click;
selecting at least one of the manual testing mode and the automatic testing mode to design the plurality of test cases;
designing the plurality of test cases based on mode of selection; and
associating the data captured with the plurality of test cases.

4. The article of manufacture of claim 3 further comprising at least one of:
capturing user interactions and behavior corresponding to the application under test;
generating one or more test steps required for execution of the plurality of test cases;
capturing one or more input variables automatically for the one or more steps generated;
modifying at least one of the captured user interactions and the one or more input variables; and
defining one or more expected results for the one or more input variables.

5. The article of manufacture of claim 3, wherein the captured component metadata can be used as reference during the modification of the test step.

6. The article of manufacture of claim 4 further comprising the set of algorithms for performing at least one of:
providing an option to select a test step, the test step selected is at least one of mandatory and optional during the capture of the test step;
providing an option to change the sequence of the one or more test steps and to add an additional step during the capture of the test step;
generating a template file to capture an input data for the plurality of test cases, wherein the template file is an external input data file; and
generating test case documentation through selection of at least a test case, a test step and a test.

7. The article of manufacture of claim 6, wherein generating a template file comprises:
overriding a data file associated during the creation of the test case in at least one of the test step and the test case with the external input data file.

8. The article of manufacture of claim 6 further comprising the set of algorithms for performing at least one of:
providing an option to add a test case as a new action to another step in the test case in order to provide the execution flow and to extend, import, and reuse the one or more test cases; and
capturing summary level details of the test case to describe the test case, test conditions, test assumptions, test risks based on a pre-set of language of choice.

9. The article of manufacture of claim 8, wherein the captured summary details comprises at least one of:
a date of creation;
an information pertaining to created user;
a date of modification;
one or more modified details;
a test case purpose; and
a test case status.

10. The article of manufacture of claim 8 further comprising:
creating a project;
managing an execution of the project for application under test;
creating one or more labels for the project time lines;
managing one or more labels for the project time lines, wherein the one or more labels can be used as a tag to apply on the project denoting the phase of the project in the overall Project development life cycle (PDLC);
creating a test suite;
managing an execution of the test suite for application under test;
creating one or more test types; and
managing the one or more test types, wherein the test types can be used as a tag to apply on the test suite denoting the phase of test.

11. The article of manufacture of claim 10, wherein managing the one or more test type comprises:
customizing one or more tags to apply for the test suite and the test case;
applying one or more tags to annotate the test suite and the test case in order to represent the test suite as at least one of the test type during phases of testing; and
promoting the one or more tags to denote the change in the test phase.

12. The article of manufacture of claim 10, wherein the one or more labels created comprises at least one of:
a build;
a release;
a alpha; and
a beta and a general availability.

13. The article of manufacture of claim 10, wherein the one or more test types created comprises at least one of:
a smoke;
an integration;
a sanity system;
a acceptance; and
a regression.

14. The article of manufacture of claim 10 further comprising the set of algorithms for performing at least one of:
defining one or more test scenarios for the project;
creating the plurality of test cases for the one or more test scenarios;
grouping the plurality of test cases relevant to the one or more test scenarios;
associating the plurality of test cases within the test suite;
configuring the one or more test scenarios with one or more component repositories to provide an option to select the runtime environment;
providing an option to execute the one or more test scenarios on the test suite by the single click;
executing the one or more test scenarios through at least one of the manual mode and the automatic mode in a trial run; and
providing an option to stop, pause and restart the execution in the trial run.

15. The article of manufacture of claim 14, wherein the configuring comprises:
selecting a browser of choice to be used for the application under test snapshot of the screen on error;
generating one or more messages to notify status of execution; and
providing an option to define exception handlers.

16. The article of manufacture of claim 14 further comprising the set of algorithms for performing at least one of:
capturing a response from the application under test;
capturing the execution screenshot of the one or more test scenarios with the project phase and the test phase based on a journal system;
validating the response from the application under test;
executing one or more sessions with the one or more test suites;
analyzing one or more results based on the captured response and the execution snapshot; and
generating the one or more reports based on the execution for a category of users.

17. The article of manufacture of claim 16, wherein executing comprises:
executing the one or more sessions in at least one of a background mode, and a foreground mode.

18. The article of manufacture of claim 16, wherein generating comprises:
generating the one or more reports with a dimension of the project phase and the test phase with respect to time based on the journal system.

19. The article of manufacture of claim 16 further comprising the set of algorithms for performing at least one of:
configuring the one or more reports;
merging the reports of the one or more test scenarios to provide a single report for the project; and
providing an option to export the reports in one or more formats.

20. The article of manufacture of claim 19, wherein configuring comprises at least one of:
retaining the one or more reports in complete; and
overriding the one or more reports and retain a latest report generated after execution.

21. The article of manufacture of claim 19 further comprising:
providing the screenshot of the test step that encountered an error during the execution.

22. The article of manufacture of claim 10, wherein creating the project comprises: creating the project with one or more project details, wherein the one or more project details comprises a description of the project, one or more users of the project, and one or more configuration details of the project.

23. The article of manufacture of claim 22, wherein the one or more configuration details of the project comprises:
a project database;
one or more communication methods;
an user access management; and
an administrator privileges.

24. The article of manufacture of claim 19 further comprising the set of algorithms for performing at least one of:
providing an option to modify the one or attributes related to the component;
providing an option to select a database for the project across a network;
creating the one or more users and assign permissions, wherein the one or more users and assign comprises a create, a view and a delete; and
terminating the project for at least one of use and re-activate of the project.

25. The article of manufacture of claim 18, wherein the one or more reports generated comprises at least one of:
a high level report;
a low level report;
a summary report;
a module report;
a test case report; and
a test step report.

26. The article of manufacture of claim 24 further comprising the set of algorithms for performing at least one of:
capturing one or more events to generate an event log for the purpose of traceability and audit of purpose; and
providing an option for a user to login and get authenticated with a central admin system in order to receive the users profile, meta-data, access to projects and permissions.

27. The article of manufacture of claim 1, wherein the automated quality assurance software testing is performed through a script less approach.

28. A computer-implemented method for performing an automated quality assurance, the computer-implemented method comprising:
selecting a plurality of test cases;
designing the plurality of test cases to perform the automated quality assurance;
calibrating the plurality of test cases and manage the plurality of test cases in a visual hierarchy;
reflecting the functional modules in a cohesive group based on the calibration;
executing the plurality of test cases through at least one of a manual testing mode and an automatic testing mode;
registering information associated with the plurality of test cases, wherein the registering comprises managing component registry information.
generating one or more reports for the plurality of test cases; and
displaying the one or more reports generated for the plurality of test cases on a visual interface.

29. The method of claim 28, wherein the plurality of test cases comprises at least one of:
a set of test data; and
test programs.

30. The method of claim 28 comprising: a set of algorithms for performing at least one of:
capturing a component metadata and a data associated with the plurality of test cases to be tested by a single click;
selecting at least one of the manual testing mode and the automatic testing mode to design the plurality of test cases;
designing the plurality of test cases based on mode of selection; and
associating the data captured with the plurality of test cases.

31. The method of claim 30 further comprising at least one of:
capturing user interactions and behavior corresponding to the application under test;
generating one or more test steps required for execution of the plurality of test cases;
capturing one or more input variables automatically for the one or more steps generated;
modifying at least one of the captured user interactions and the one or more input variables; and
defining one or more expected results for the one or more input variables.

32. The method of claim 30, wherein the captured component metadata can be used as reference during the modification of the test step.

33. The method of claim 31 further comprising the set of algorithms for performing at least one of:
providing an option to select a test step, the test step selected is at least one of mandatory and optional during the capture of the test step;
providing an option to change the sequence of the one or more test steps and to add an additional step during the capture of the test step;
generating a template file to capture an input data for the plurality of test cases, wherein the template file is an external input data file; and
generating test case documentation through selection of at least a test case, a test step and a test.

34. The method of claim 33, wherein generating a template file comprises:
overriding a data file associated during the creation of the test case in at least one of the test step and the test case with the external input data file.

35. The method of claim 33 further comprising the set of algorithms for performing at least one of:
providing an option to add a test case as a new action to another step in the test case in order to provide the execution flow and to extend, import, and reuse the one or more test cases; and
capturing summary level details of the test case to describe the test case, test conditions, test assumptions, test risks based on a pre-set of language of choice.

36. The method of claim 35, wherein the captured summary details comprises at least one of:
a date of creation;
an information pertaining to created user;
a date of modification;
one or more modified details;
a test case purpose; and
a test case status.

37. The method of claim 35 further comprising:
creating a project;
managing an execution of the project for application under test;
creating one or more labels for the project time lines;
managing one or more labels for the project time lines, wherein the one or more labels can be used as a tag to apply on the project denoting the phase of the project in the overall Project development life cycle (PDLC);
creating a test suite;
managing an execution of the test suite for application under test;
creating one or more test types; and
managing the one or more test types, wherein the test types can be used as a tag to apply on the test suite denoting the phase of test.

38. The method of claim 37, wherein managing the one or more test type comprises:
customizing one or more tags to apply for the test suite and the test case;
applying one or more tags to annotate the test suite and the test case in order to represent the test suite as at least one of the test type during phases of testing; and
promoting the one or more tags to denote the change in the test phase.

39. The method of claim 37, wherein the one or more labels created comprises at least one of:
a build;
a release;
a alpha; and
a beta and a general availability.

40. The method of claim 37, wherein the one or more test types created comprises at least one of:
a smoke;
a integration;
a sanity system;
a acceptance; and
a regression.

41. The method of claim 37 further comprising the set of algorithms for performing at least one of:
defining one or more test scenarios for the project;
creating the plurality of test cases for the one or more test scenarios;
grouping the plurality of test cases relevant to the one or more test scenarios;
associating the plurality of test cases within the test suite;
configuring the one or more test scenarios with one or more component repositories to provide an option to select the runtime environment;
providing an option to execute the one or more test scenarios on the test suite by the single click;
executing the one or more test scenarios through at least one of the manual mode and the automatic mode in a trial run; and
providing an option to stop, pause and restart the execution in the trial run.

42. The method of claim 41, wherein the configuring comprises:
selecting a browser of choice to be used for the application under test snapshot of the screen on error;
generating one or more messages to notify status of execution; and
providing an option to define exception handlers.

43. The method of claim 41 further comprising the set of algorithms for performing at least one of:
capturing a response from the application under test;
capturing the execution screenshot of the one or more test scenarios with the project phase and the test phase based on a journal system;
validating the response from the application under test;
executing one or more sessions with the one or more test suites;
analyzing one or more results based on the captured response and the execution snapshot; and
generating the one or more reports based on the execution for a category of users.

44. The method of claim 43, wherein executing comprises:
executing the one or more sessions in at least one of a background mode, and a foreground mode.

45. The method of claim 43, wherein generating comprises:
generating the one or more reports with a dimension of the project phase and the test phase with respect to time based on the journal system.

46. The method of claim 43 further comprising the set of algorithms for performing at least one of:
configuring the one or more reports;
merging the reports of the one or more test scenarios to provide a single report for the project; and
providing an option to export the reports in one or more formats.

47. The method of claim 46, wherein configuring comprises at least one of:
retaining the one or more reports in complete; and
overriding the one or more reports and retain a latest report generated after execution.

48. The method of claim 46 further comprising:
providing the screenshot of the test step that encountered an error during the execution.

49. The method of claim 37, wherein creating the project comprises:
creating the project with one or more project details, wherein the one or more project details comprises a description of the project, one or more users of the project, and one or more configuration details of the project.

50. The method of claim 49, wherein the one or more configuration details of the project comprises:
a project database;
one or more communication methods;
an user access management; and
an administrator privileges.

51. The method of claim 46 further comprising the set of algorithms for performing at least one of:
providing an option to modify the one or attributes related to the component;
providing an option to select a database for the project across a network;
creating the one or more users and assign permissions, wherein the one or more users and assign comprises a create, a view and a delete; and
terminating the project for at least one of use and re-activate of the project.

52. The method of claim 45, wherein the one or more reports generated comprises at least one of:
a high level report;
a low level report;
a summary report;
a module report;
a test case report; and
a test step report.

53. The method of claim 51 further comprising the set of algorithms for performing at least one of:
capturing one or more events to generate an event log for the purpose of traceability and audit of purpose;
providing an option for a user to login and get authenticated with a central admin system in order to receive the users profile, meta-data, access to projects and permissions; and

54. The method of claim 28, wherein the automated quality assurance software testing is performed through a script less approach.

55. A system for performing an automated quality assurance comprising:
a server, the server comprises:
a administrator module; and
a client module for:
selecting a plurality of test cases;
capturing a component metadata and a data associated with the plurality of test cases to be tested by a single click; and
selecting at least one of the manual testing mode and the automatic testing mode to design the plurality of test cases.

56. The system of claim 55, wherein the client module comprises:
a processor, the processor for:
designing the plurality of test cases to perform the automated quality assurance;
calibrating the plurality of test cases and manage the plurality of test cases in a visual hierarchy;
reflecting the functional modules in a cohesive group based on the calibration;
executing the plurality of test cases through at least one of a manual testing mode and an automatic testing mode;
registering information associated with the plurality of test cases, wherein the registering comprises managing component registry information; and
generating one or more reports for the plurality of test cases.
a visual interface for:
displaying the one or more reports generated for the plurality of test cases in a grid format with project phase being denoted in the timeline of the project in one axis and the test type being denoted in the phase of testing as another axis on a visual interface in the client module.

57. The system of claim 56, wherein visual interface for:
displaying a list of one or more captured components, the list of the one or more captured components is used as reference during modification of a test step and creation of the test step;
displaying disparate set of one or more component repositories that can be switched during the modification of the test case;
providing an option to upload an external file, the external file comprising one or more input data to be used during the execution of the test step;
providing an option to allow the user to browse for one or more test cases;
displaying a pre-defined list of actions to perform one or more tasks during the execution of the test step;
displaying the one or more execution details;
displaying the status of the project with one or more details, wherein the one or more details comprises at least one of a number of active projects, a number of logged in users and a list of logged in users for the project; and
displaying the one or more projects automatically to a user, the user as access to sub-systems and the visual interface.

58. The system of claim 56, wherein the processor comprises:
a designer for designing the plurality of test cases to perform quality assurance software;
an executor executing the plurality of test cases through at least one of a manual testing mode and an automatic testing mode;
a registry for registering information associated with the plurality of test cases; and
a reporter for generating one or more reports for the plurality of test cases based on the registration of information.

59. The system of claim 57, wherein the displaying the one or more execution details comprises:
a progress of execution;
a number of test cases passed;
a number of test cases failed; and
a number of test cases skipped along with the execution start time.

60. The system of claim 56, wherein the visual interface for:
providing an option to manage a component repository.

61. The system of claim 60, wherein the component repository comprises:
a list of one or more components captured across the user interface of the application under test.
